(19) United States
(12) Patent Application Publication
(10) Pub. No.: US 2012/0263871 A1
(43) Pub. Date: Oct. 18, 2012

(54) OPTICAL FILM AND METHOD FOR PRODUCTION THEREOF

(75) Inventors: Toshiyuki IIDA, Ibaraki-shi (JP); Tomoyuki Hirayama, Ibaraki-shi (JP); Yutaka Ohmori, Ibaraki-shi (JP); Miyuki Kurogi, Ibaraki-shi (JP); Hisae Shimizu, Ibaraki-shi (JP)

(73) Assignee: NITTO DENKO CORPORATION, Osaka (JP)

(21) Appl. No.: 13/530,351

(22) Filed: Jun. 22, 2012

Related U.S. Application Data
(62) Division of application No. 12/439,795, filed on Mar. 3, 2009.

(30) Foreign Application Priority Data
Sep. 7, 2007 (JP) 2007-233068
Oct. 16, 2007 (JP) 2007-269266

(51) Int. Cl. B05D 5/06

(52) U.S. Cl. 427/162

(57) ABSTRACT

The invention relates to a resin solution containing polyester with a specific structure, an optical film containing the polyester, and methods for production thereof Further, the invention also relates to an optical laminate, a polarizing plate, and an image display device each using the optical film. The polyester may be obtained by condensation polymerization of dicarboxylic acid compound(s) and bisphenol compound(s), and preferably has no halogen atom in its chemical structure. According to the invention, high productivity of the optical film can be achieved since the polyester has a high solubility in solvents, and an environmental loading for production can be reduced.

### CROSS REFERENCE TO RELATED APPLICATIONS

This application is a divisional application of U.S. patent application Ser. No. 12/439,795, filed Mar. 3, 2009, which is a National Stage Entry of PCT/JP2008/064993, filed Aug. 22, 2008, which is based upon and claims the benefit of priority of the prior Japanese Patent Application No. 2007-233068, filed Sep. 7, 2007 and Japanese Patent Application No. 2007-269266, filed Oct. 16, 2007, the entire contents of which are incorporated herein by reference.

### TECHNICAL FIELD

The invention relates to an optical film used for optical compensation or the like of liquid crystal displays, an optical laminate including the optical film, and methods for production thereof. The invention also relates to a resin solution for use in the production thereof The invention also relates to a polarizing plate using the optical film and/or the optical laminate and to an image display device such as a liquid crystal display, an organic electroluminescence (EL) display, or a plasma display panel (PDP), using the optical film and/or the optical laminate.

### BACKGROUND ART

In conventional technologies, birefringent polymer materials have been used for optical compensation or the like of liquid crystal displays. Such optical compensation materials that are widely used include plastic films that have undergone stretching or the like so that they have birefringence. In recent years, an optical compensation material including a substrate coated with a polymer having high birefringence-producing capability, such as aromatic polyimide or aromatic polyester, has also been developed (see for example Patent Documents 1 and 2).

Such an aromatic polymer is characterized by having a high level of heat resistance and mechanical strength but tends to have low solubility in organic solvents. Therefore, an optical film mainly composed of such an aromatic polymer is generally formed by a process including the steps of dissolving the polymer in a high-polarity solvent, which therefore has high solubility, to form a resin solution, and then applying the resin solution to a metallic drum or metallic belt or a base film or the like and drying it to form a film. In such a film production method, however, since a choice of solvents capable of dissolving the polymer is limited, drying conditions may be restricted, or expensive equipment may be needed. Since the substrate used in the coating process has to be insoluble in the solvent, materials usable for the substrate are also limited. From these points of view, it has been demanded to develop a polymer that is soluble in a low-polarity solvent such as toluene and has birefringence-producing capability so that it can function as an optical compensation material.

Patent Document 1: the pamphlet of PCT International Publication No. WO94/24191

Patent Document 2: Japanese Patent Application Laid-Open (JP-A) No. 2004-070329

### DISCLOSURE OF INVENTION

### Problems to be Solved by the Invention

An object of the invention is to provide an optical film including a highly-soluble aromatic polymer and to provide a method for production thereof. Another object of the invention is to provide an optical laminate, a polarizing plate, and an image display device each using the optical film.

### Means for Solving the Problems

As a result of investigations, the inventors have found that the problems described above can be solved using an optical film containing a polyester with a specific structure, and have completed the invention. Specifically, the invention is directed to an optical film including an ester-based polymer having a repeating unit represented by formula (I):

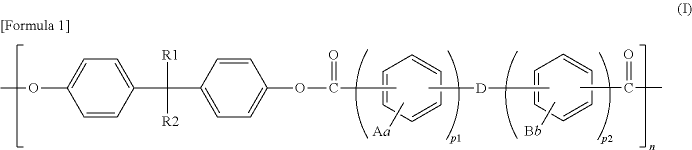

In the formula (I) above, A and B each represent a substituent, a and b represent the number of the substituents A and the number of the substituents B, respectively, each of which is an integer of 0 to 4,
A and B each independently represent hydrogen, halogen, an alkyl group of 1 to 6 carbon atoms, or a substituted or unsubstituted aryl group,
D represents a covalent bond or at least one atom or group selected from the group consisting of a CH₂ group, a C(CH₃)₂ group, a C(CZ₃)₂ group, wherein Z is halogen, a CO group, an O atom, a S atom, a SO₂ group, a Si(CH₂CH₃)₂ group, and an N(CH₃) group,
R1 represents a straight-chain or branched alkyl group of 1 to 10 carbon atoms or a substituted or unsubstituted aryl group,
R2 represents a straight-chain or branched alkyl group of 2 to 10 carbon atoms or a substituted or unsubstituted aryl group,
p1 represents an integer of 0 to 3, p2 represents an integer of 1 to 3, and
n represents an integer of 2 or more.

Furthermore, in the formula (I) with respect to the optical film of the invention, R1 preferably represents a methyl group, and R2 preferably represents a straight-chain or branched alkyl group of 2 to 4 carbon atoms.

Furthermore, in a preferable embodiment of the optical film of the invention, the ester-based polymer is a non-halogenated ester-based polymer having no halogen atom in its chemical structure.

Furthermore, in a preferable embodiment of the optical film of the invention, the ester-based polymer is soluble in toluene or xylene.

Furthermore, in a preferable embodiment of the optical film of the invention, it has a transmittance of 90% or more at a wavelength of 400 nm.

Furthermore, in a preferable embodiment of the optical film of the invention, it has a thickness of 20 μm or less.

Furthermore, in a preferable embodiment of the optical film of the invention, its refractive index (nz) in the film thickness direction is smaller than the maximum (nx) of its in-plane refractive index.

The invention is also directed to a resin solution suitable for use in the production of the optical film. The resin solution of the invention preferably includes a solvent including 50 parts by weight or more of toluene based on 100 parts by weight of the solvent, and the ester-based polymer dissolved in the solvent.

The invention is also directed to an optical laminate including a polymer substrate and the optical film placed on and bonded to the polymer substrate.

The invention is also directed to a polarizing plate including a polarizer and the optical film or the optical laminate.

The invention is also directed to an image display including at least one of the optical film, the optical laminate, and the polarizing plate.

The invention is also directed to a method for producing the optical film, comprising the steps of:
preparing a resin solution comprising the ester-based polymer represented by the formula (I) and a solvent; and
applying the resin solution to a surface of a polymer substrate and drying the solution so that a film placed on and bonded to the polymer substrate is formed.

Further, the invention is also directed to a method for producing the optical laminate, comprising the steps of:
preparing a resin solution comprising the ester-based polymer represented by the formula (I) and a solvent; and
applying the resin solution to a surface of a polymer substrate and drying the solution so that a film placed on and bonded to the polymer substrate is formed.

Further, the invention is also directed to a method for producing the optical laminate, comprising the steps of:
preparing a resin solution comprising the ester-based polymer represented by the formula (I) and a solvent; and
applying the resin solution to a surface of a polymer substrate and drying the solution so that a film placed on and bonded to the polymer substrate is formed.

In a preferable embodiment of method for producing the optical film or the optical laminate, the solvent comprises 50 parts by weight or more of toluene, based on 100 parts by weight of the solvent.

### BRIEF DESCRIPTION OF DRAWINGS

FIG. 1 is a sectional view schematically illustrating an example of the structure of the polarizing plate of the invention.

FIG. 2 is a sectional view schematically illustrating an example of the structure of the polarizing plate of the invention.

FIG. 3 is a sectional view schematically illustrating an example of the structure of the polarizing plate of the invention.

FIG. 4 is a sectional view schematically illustrating an example of the structure of the polarizing plate of the invention.

FIG. 5 is a graph showing the result of measurement of the viscosity of resin solutions obtained in Examples 2 and 3.

### DESCRIPTION OF REFERENCE SYMBOLS

In the drawings, reference symbol P represents a polarizer, R an optical film, T a transparent protective film, S a substrate, and 1 an optical laminate.

### BEST MODE FOR CARRYING OUT THE INVENTION

The optical film of the invention includes an ester-based polymer having the repeating unit represented by formula (I) below.

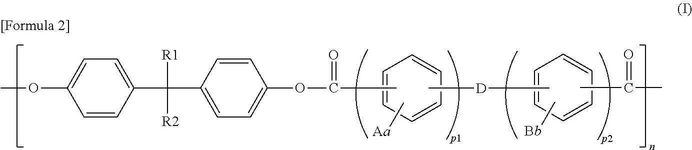

In formula (I), A and B each represent a substituent, a and b represent the number of the substituents A and the number of the substituents B, respectively, each of which is an integer of 0 to 4. A and B each independently represents hydrogen, halogen, an alkyl group of 1 to 6 carbon atoms, or a substituted or unsubstituted aryl group. D represents a covalent bond or at least one atom or group selected from the group consisting of a CH₂ group, a C(CH₃)₂ group, a C(CZ₃)₂ group, wherein Z is halogen, a CO group, an O atom, a S atom, a SO₂ group, a Si(CH₂CH₃)₂ group, and an N(CH₃) group. R1 represents a straight-chain or branched alkyl group of 1 to 10 carbon atoms or a substituted or unsubstituted aryl group. R2 represents a straight-chain or branched alkyl group of 2 to 10 carbon atoms or a substituted or unsubstituted aryl group. pl represents an integer of 0 to 3, p2 represents an integer of 1 to 3, and n represents an integer of 2 or more.

When A, B, R1, or R2 is an unsubstituted aryl group, the unsubstituted aryl group may be a phenyl group, a biphenyl group, a terphenyl group, a naphthyl group, a binaphthyl group, a triphenylphenyl group, or the like. When A, B, R1, or R2 is a substituted aryl group, the substituted aryl group may be derived from the unsubstituted aryl group by replacing one or more hydrogen atoms by a straight-chain or branched alkyl group of 1 to 10 carbon atoms, a straight-chain or branched alkoxy group of 1 to 10 carbon atoms, a nitro group, an amino group, a silyl group, halogen, a halogenated alkyl group, a phenyl group, or the like. Further, the halogen (Z) may be fluorine, chlorine, bromine, iodine, or the like.

In formula (I), R1 is preferably a methyl group, and R2 is preferably a straight-chain or branched alkyl group of 2 to 4 carbon atoms, in particular, ethyl or isobutyl. When R1 and/or R2 is an alkyl group of too many carbon atoms, birefringence may be less likely to be produced, or heat resistance (glass transition temperature) may be reduced. When the number of the carbon atoms is too small such as in a case where R1 and R2 are both methyl groups, the solubility of the polymer in solvents may be reduced so that it may be difficult to produce a film with a solvent of low polarity such as toluene or xylene. Although the reason why the solubility varies with the number of the carbon atoms in the substituent group is not clear, this may be because stacking between the aromatic rings can be overcome by the steric hindrance caused by R1 and R2.

In an embodiment of the invention, the ester-based polymer is preferably a non-halogenated ester-based polymer having no halogen atom in its chemical structure, in view of environmental loading reduction. In conventional technologies, halogen atoms are often used in polymer structures, in order to impart solubility in solvents or the like to aromatic polymers. However, halogen atom-containing polymers may have the problem of environmental loading such as a tendency to produce dioxins upon low-temperature combustion. In contrast, the ester-based polymer with a specific combination of R1 and R2 for use in the optical film of the invention is highly soluble in solvents even when it contains no halogen atom in its chemical structure.

Note that the ester-based polymer may be a copolymer having different monomer units each represented by general formula (I) in which the monomer units differ in any of R1, R2, A, B, D, a, b, and p.

In order to achieve solubility in solvents and birefringence-producing capability at the same time, D, p1, and p2 in general formula (I) are preferably a covalent bond and p1 and p2 are 0 and 1, respectively. Specifically, the polymer preferably has a structure represented by general formula (II) below. In particular, the polymer preferably has a structure represented by general formula (III) below in which a terephthalic acid derivative is used as an acid component or preferably has a copolymer structure represented by general formula (IV) below in which a terephthalic acid derivative and an isophthalic acid derivative are used. Particularly in view of solubility in general-purpose solvents, the ester-based polymer is preferably a copolymer having a structure represented by general formula (IV) below.

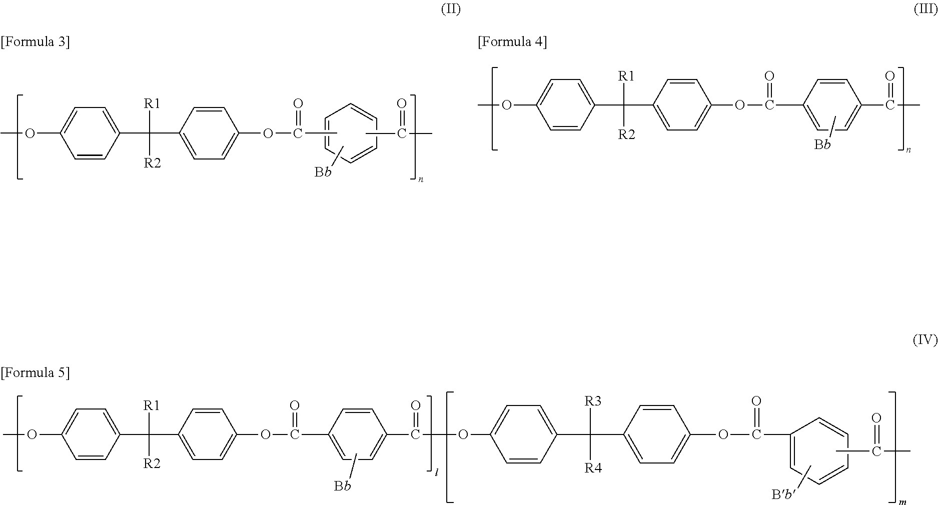

Note that in general formulae (II) to (IV), Aa, Bb, R1, and R2 each have the same meaning as defined in general formula (I); R3 and R4 have the same meaning as defined for R1 and R2, respectively; B′b′ has the same meaning as defined for Bb; and n, 1, and m are each an integer of 2 or more. The polymer having the structure represented by general formula (IV) may have any sequence with no particular limitation and may be any of a block copolymer and a random copolymer, although block copolymers are suggested by general formula (IV) for convenience of illustration.

In the polyester represented by general formula (IV), the content of the terephthalic acid derivative-derived structure in the acid components, namely the 1/(1+m) value, is preferably 0.3 or more, more preferably 0.5 or more, even more preferably 0.6 or more. When the 1/(1+m) value is too small, heat resistance can be insufficient, or birefringence-producing capability can be reduced, although high solubility can be provided.

The ester-based polymer for use in the optical film of the invention may contain any other repeating unit, as long as it contains any of the structures represented by general formulae (I) to (IV), respectively. The content of the structure or structures represented by any of general formulae (I) to (IV) is preferably, but not limited to, 50% by mole or more, more preferably 70% by mole or more, even more preferably 80% by mole or more, as long as the desired solubility of the polymer according to the invention and the birefringence-producing capability can be maintained.

The ester-based polymer preferably has a weight-average molecular weight (Mw) of 3,000 or more, more preferably from 5,000 to 1,000,000, even more preferably from 10,000 to 500,000, most preferably from 50,000 to 350,000. When the molecular weight is too low, the film strength can be insufficient, or optical properties can significantly change upon exposure to a high-temperature environment. When the molecular weight is too high, the productivity of the optical film can be reduced due to a reduction in the solubility in solvents, or the like. In addition, the Mw may be determined by the measurement method described later in the section of EXAMPLES.

The glass transition temperature of the polymer is preferably, but not limited to, 100° C. or more, more preferably 120° C. or more, even more preferably 150° C. or more, in view of the heat resistance of the optical film. In view of formability, workability such as stretchability, the glass transition temperature is also preferably 300° C. or less, more preferably 250° C. or less.

The ester-based polymer for use in the optical film of the invention may be produced by known methods with no particular limitation. In general, it may be obtained by condensation polymerization of a dicarboxylic acid compound(s) or a derivative(s) thereof and a corresponding bisphenol compound(s).

A variety of condensation polymerization methods are generally known, such as melt condensation polymerization methods by removal of acetic acid, melt condensation polymerization methods by removal of phenol, dehydrochlorination homogeneous polymerization methods that are performed in an organic solvent system capable of dissolving the polymer and use the dicarboxylic acid compound in the form of an acid dichloride and an organic base, interfacial condensation polymerization methods in which dicarboxylic acid dichloride and bisphenol are polymerized in a two-phase system of an aqueous alkali solution and a water-immiscible organic solvent, and direct condensation polymerization methods in which a bisphenol compound and a dicarboxylic acid are directly used with a condensing agent to form an active intermediate in the reaction system. In particular, the ester-based polymer is preferably produced by interfacial condensation polymerization, in view of transparency, heat resistance, and high-molecular-weight production.

When the ester-based polymer is produced by interfacial condensation polymerization, monomers (bisphenol and dicarboxylic acid chloride), an organic solvent, an alkali, a catalyst, and so on may be used.

Examples of dicarboxylic acid chloride include unsubstituted aromatic acid dichlorides such as terephthalic acid chloride, isophthalic acid chloride, phthalic acid chloride, 4,4′-diphenyldicarboxylic acid chloride; and derivatives thereof having a substituent(s) corresponding to an example(s) of A or B in formula (I) as described above.

Examples of bisphenol include 2,2-bis(4-hydroxyphenyl)butane, 2,2-bis(4- hydroxyphenyl)-4-methyl-pentane, 3,3-bis(4-hydroxyphenyl)pentane, 2,2-bis(4- hydroxyphenyl)hexane, 1,1-bis(4-hydroxyphenyl)-1-phenylmethane, and bis(4- hydroxyphenyl)diphenylmethane.

The organic solvent used for the polymerization reaction is preferably, but not limited to, one that is less miscible with water and capable of dissolving the ester-based polymer, such as a halide solvent such as dichloromethane, chloroform, or 1,2-dichloroethane, or anisole. Two or more of these solvents may be used in the form of a mixture.

The alkali to be used may be sodium hydroxide, potassium hydroxide, lithium hydroxide, or the like. The amount of the alkali used is generally from 2 to 5 times by mole (1 to 2.5 molar equivalents) the amount of the bisphenol monomer.

The catalyst that may be used is preferably a phase transfer catalyst such as a quaternary ammonium salt such as tetrabutylammonium bromide, trioctylmethylammonium chloride, or benzyltriethylammonium chloride; a quaternary phosphonium salt such as tetraphenylphosphonium chloride or triphenylmethylphosphonium chloride; or a polyethylene oxide compound such as polyethylene glycol, polyethylene glycol monomethyl ether, polyethylene glycol dimethyl ether, dibenzo-18-crown-6, or dicyclohexyl-18-crown-6. In particular, tetraalkylammonium halides are preferably used in view of handleability such as removability of the catalyst after the reaction. If necessary, any other additive such as an antioxidant or a molecular weight modifier may also be used.

Methods for controlling the molecular weight of the ester-based polymer include a method of changing the functional group ratio between the hydroxyl group and the carboxyl group for polymerization and a method of adding a monofunctional substance as a molecular weight modifier in the polymerization process. Examples of such a monofunctional substance used as a molecular weight modifier include monofunctional phenols such as phenol, cresol, and p-tert-butylphenol; monofunctional chlorides such as benzoic acid chloride, methanesulfonyl chloride, and phenyl chloroformate; and monofunctional alcohols such as methanol, ethanol, n-propanol, isopropanol, n-butanol, pentanol, hexanol, dodecyl alcohol, stearyl alcohol, benzyl alcohol, and phenethyl alcohol. After the polymerization reaction, a monofunctional acid chloride may be allowed to react so that the terminal phenol can be sealed. The terminal sealing is preferably used, because it can prevent oxidative coloration of the phenol. An antioxidant may also be concomitantly used in the polymerization process.

When an interfacial condensation polymerization reaction is used, the polymerization reaction yields a mixture of an aqueous phase and an organic phase, which contains not only a polymer, an organic solvent and water but also a catalyst and impurities such as remaining monomers. When interfacial condensation polymerization is performed with a halide solvent, water-soluble impurities are generally removed by a method of washing with water that includes repeating a separation process including separation and removal of the aqueous phase. After washing with water, if necessary, reprecipitation may be performed using a water-miscible organic solvent serving as a poor solvent for the polymer, such as acetone or methanol. The reprecipitation with the water-miscible organic solvent allows dehydration and desolvation so that a powder can be produced and that hydrophobic impurities such as bisphenol compounds can be reduced in many cases.

A solvent that is less compatible with water and cannot dissolve 0.5% by weight or more of the ester-based polymer is preferably used as a water-immiscible organic solvent serving as a poor solvent for the polymer. The boiling point of the solvent is preferably 120° C. or less so that the solvent can be easily removed by heat drying. Preferred examples of such a solvent include hydrocarbons such as cyclohexane and isophorone; and alcohols such as methanol, ethanol, propanol, and isopropyl alcohol, but preferred examples are variable, because the solubility depends on the polymer type.

The concentration of the monomers added for the interfacial condensation polymerization and the concentration of the polymer for post treatment are preferably set high so that high productivity can be provided. The interfacial condensation polymerization preferably has a concentration such that the amount of the polymer can be 1% by weight or more, preferably 3% by weight or more, more preferably 5% by weight or more, based on the total amount of the liquid including the aqueous phase and the organic phase obtained after the reaction.

The reaction temperature is preferably, but not limited to, from -5° C. to 50° C., more preferably from 5° C. to 35° C., particularly preferably from 10° C. to 30° C. or near room temperature. When the reaction temperature falls within the range, the viscosity and the temperature can be easily controlled during the reaction, and adverse reactions such as hydrolysis and oxidative coloration can be reduced.

In order to prevent side reactions, the reaction temperature may be previously set low in consideration of generation of heat associated with the polymerization reaction. In order to allow the reaction to proceed gradually, an alkali solution or dicarboxylic acid dichloride may be gradually added, or the solution may be added dropwise. The addition of the alkali solution or dicarboxylic acid dichloride in such a manner may be performed in a short time period such as 10 minutes or less, but is preferably performed over 10 to 120 minutes, more preferably 15 to 90 minutes, in order to suppress the generation of heat. In order to prevent oxidative coloration, the reaction is preferably allowed to proceed under an inert gas atmosphere such as nitrogen.

After the addition of the alkali solution and dicarboxylic acid dichloride, the reaction time is generally from 10 minutes to 10 hours, preferably 30 minutes to 5 hours, more preferably 1 to 4 hours, while it varies with the type of the monomers, the amount of the alkali used, or the concentration of the alkali.

After the interfacial condensation polymerization reaction is completed, the resulting ester-based polymer may be subjected to separation and washing with water and then used in the form of a resin solution without modification or formed into a powder with a poor solvent. In addition, in view of reducing an environmental loading, the polyester according to the invention preferably has a halide solvent content of 1000 ppm or less, more preferably 300 ppm or less, even more preferably 100 ppm or less, particularly preferably 50 ppm or less. The ester-based polymer described above has particularly high solubility in solvents and is also soluble in non-halogen solvents. Therefore, non-halogen solvents (such as toluene, cyclohexanone, and anisole) may be used in the polymerization process so that the halogen content of the polymer product can be reduced.

The optical film of the invention may be produced with the ester-based polymer by known methods such as coating methods from a solution and melt extrusion methods to produce the film. In view of smoothness of the optical film, uniformity of the optical properties, or birefringence-producing capability, the optical film is preferably produced from a solution by coating methods.

When the film is produced from a solution by a coating method, the process may include the steps of preparing a resin solution containing the ester-based polymer and a solvent, applying the resin solution to the surface of a substrate, and drying the solution so that a film placed on and bonded to the substrate is formed.

Any appropriate solvent capable of dissolving the ester-based polymer may be selected for the resin solution depending on the type of the polymer. Examples of such a solvent include chloroform, dichloromethane, toluene, xylene, cyclohexanone, and cyclopentanone. One or more of these solvents may be used alone or in any combination. A poor solvent may also be added, as long as the ester-based polymer can be dissolved.

Specifically in order to reduce environmental loading, non-halogen solvents are preferably used, such as aromatic hydrocarbons, ketones, and esters. In particular, toluene, xylene, cyclohexanone, or cyclopentanone is preferably used, and toluene is most preferably used. A mixed solvent containing any of these solvents may also be preferably used. When a mixed solvent is used, the amount of the above solvent in 100 parts by weight of the mixed solvent is preferably 50 parts by weight or more, more preferably 80 parts by weight or more. In particular, the amount of toluene in 100 parts by weight of the mixed solvent is preferably 50 parts by weight or more, more preferably 80 parts by weight or more. Since the ester-based polymer has high solubility, such low-polarity solvents may be used for the film production. In a solvent containing 50 parts by weight or more of toluene based on 100 parts by weight of the solvent, the additional solvent component other than toluene may be cyclopentanone, cyclohexanone, 4-methyl-2-pentanone (methyl isobutyl ketone (MIBK)), N,N-dimethylacetamide (DMAc), dimethylformamide (DMF), or dimethylsulfoxide (DMSO), in order to control the solubility of the solute such as the ester-based polymer or control the drying speed.

When toluene, whose boiling point is lower than that of polar solvents, is used as a solvent for the resin solution, an optical film having a relatively high birefringence (Δnxz=nx−nz) in the thickness direction as described below can be produced. Although the reason why the use of toluene can increase the birefringence in the thickness direction is not clear, this may be caused by the fact that the residual solvent content of the optical film is reduced or that toluene has a high drying speed as compared with solvents with relatively high boiling points and can facilitate molecular alignment.

Further, the resin solution may also contain an additional resin other than the ester-based polymer as long as the birefringence-producing capability or transparency is not significantly reduced. Examples of the additional resin include various types of general-purpose resins, engineering plastics, thermoplastic resins, and thermosetting resins.

Various types of additives that meet the purpose of each preparation step (such as an antidegradant, an anti-ultraviolet agent, an optical anisotropy-adjusting agent, a delamination promotion agent, a plasticizer, an infrared-absorbing agent, and a filler) may be added to the resin solution. They may be solid or oily and therefore does not have to have a specific melting or boiling point.

When the additional resin other than the ester-based polymer, the additive, or the like is added to the resin solution, the amount of it is preferably, but not limited to, 0 to 100 parts by weight, more preferably 0 to 50 parts by weight, even more preferably 0 to 25 parts by weight, based on 100 parts by weight of the ester-based polymer, in view of solubility and production of the optical film with high birefringence-producing capability.

The resin solution is typically prepared using a method including the step of gradually adding the ester-based polymer in the form of a powder, pellets, tablets, or the like to the solvent under stirring to dissolve the ester-based polymer until the desired concentration is reached, while the resin solution may be prepared by known methods with no particular limitation. A powder of the ester-based polymer may be produced by a method including the steps of adding the reaction solution after the completion of the polymerization reaction dropwise to a poor solvent, separating the precipitate by filtration, and washing the precipitate, or by a method of grinding the resulting resin block. Pellets or tablets may also be obtained using a pelletizer, a tablet-forming machine, or the like.

For example, the concentration of the polymer in the resin solution is preferably, but not limited to, from 1 to 30% by weight, more preferably from 1 to 20% by weight, in order to make the viscosity of the solution suitable for coating. Herein, the term “viscosity of the solution suitable for coating” means a viscosity that provides fluidity such that defects such as stripe-like unevenness of coating are not produced during the coating process. In general, such a viscosity is preferably, but not limited to, 400 mPa·second or less, more preferably 300 mPa√second or less, while it varies depending on the substrate used for the coating, the coating speed, the coating thickness, or the like. Particularly when the optical film has a thickness of not more than 20 μm, stripe-like defects tend to occur, and, therefore, the viscosity of the solution should preferably fall within the above range. On the other hand, the viscosity of the resin solution is preferably 1 mPa·second or more. When the viscosity of the solution is too low, the fluidity is too high so that it may tend to be difficult to control the thickness of the optical film as desired. As used herein, the term “the viscosity of the solution” refers to a value measured at 25° C.

The optical film may be obtained by the steps of applying the resin solution to a substrate and appropriately drying the coating. The substrate to be used is typically, but not limited to, an endless substrate such as an endless belt or a drum-roller, or a finite-length substrate such as a polymer film. When the optical film of the invention is self-supporting, any of the endless substrate and the finite-length substrate may be used. The term “self-supporting” means that it is possible to handle the film even when the film is separated from the substrate, generally in a case where the film has a thickness of about 15 to about 500 μm, more preferably about 20 to about 300 μm. When the film has a thickness exceeding the range, too large thickness can cause problems with mass production, such as long time and high energy necessary for evaporation of the solvent and difficulty in obtaining uniform thickness.

When the optical film of the invention has a thickness of less than the above range, specifically about 1 to about 20 μm or 2 to 15 μm, the finite-length substrate is preferably used. Methods using an endless substrate such as an endless belt or a drum-roller require the steps of separating the optical film from the substrate and transporting the film, and therefore are generally not suitable for the production of non-self-supporting films. In such a case, such an infinite-length substrate as a glass plate or a polymer film should be used so that the optical film of the invention can be formed as a coating film on the substrate. The term “optical film” used in the description and claims encompasses not only a self-supporting film but also a non-self-supporting coating film.

Among the infinite-length substrates, the polymer substrate is preferably used in view of handleability. Examples of the polymer substrate include polymer films made of a transparent polymer such as a polyester-based polymer such as polyethylene terephthalate or polyethylene naphthalate, a cellulose-based polymer such as diacetylcellulose or triacetylcellulose, a polycarbonate polymer, an acrylic polymer such as poly(methyl methacrylate), a styrene-based polymer such as polystyrene or an acrylonitrile-styrene copolymer, an olefin-based polymer such as polyethylene, polypropylene, a cyclic or norbornene structure-containing polyolefin, or an ethylene-propylene copolymer, a vinyl chloride-based polymer, an amide-based polymer such as nylon or an aromatic polyamide, an imide-based polymer, a sulfone-based polymer, a polyethersulfone-based polymer, a polyetheretherketone-based polymer, a polyphenylene sulfide-based polymer, a vinyl alcohol-based polymer, a vinylidene chloride-based polymer, a vinyl butyral-based polymer, an acrylate-based polymer, a polyoxymethylene-based polymer, or an epoxy-based polymer, or any blend thereof.

The polymer substrate may be a polymer film alone or a laminate of a polymer film and a layer or layers formed thereon, such as an anchor coat layer or an antistatic layer. In addition, a film that has undergone corona treatment, plasma treatment, saponification, or the like so as to have improved adhesive properties, may also be used. An optically functional film such as the reflective polarizing plate disclosed in Japanese Patent Application National Publication (Laid-Open) No. 09-506837 may also be used as the substrate.

In an embodiment of the invention, since the ester-based polymer has high solubility such that a low-polarity solvent such as toluene can be used to form a solution, a film mainly composed of an acrylic or olefin polymer that generally has low solvent resistance may also be used as the substrate.

Examples of the coating method include spin coating, roll coating method, flow coating method, printing method, dip coating method, film casting method, bar coating method, and gravure printing method. If necessary, multilayer coating may also be used in the coating process.

The resin solution applied to the substrate is then dried to form an optical film on the substrate. Examples of the drying method include natural drying and drying by heating. The drying conditions may be appropriately determined depending on the type of the solvent, the type of the polymer, the concentration of the polymer, or the like. For example, the drying temperature is generally from 25° C. to 300° C., preferably from 50° C. to 200° C., particularly preferably from 60° C. to 180° C. Note that the drying may be performed at a constant temperature or performed while the temperature is gradually raised or lowered. The drying time is also not particularly limited. The solidifying time is generally from 10 seconds to 60 minutes, preferably from 30 seconds to 30 minutes. Further, when the optical film is self-supporting, it may be temporarily separated from the support and then dried.

As described above, the optical film of the invention may be any of a self- supporting film with a relatively large thickness and a non-self-supporting film with a relatively small thickness. Since the ester compound described above has high birefringence-producing capability, the optical film of the invention is preferably used in the form of a coating film. As described above, such a coating film may be formed on the substrate by applying the resin solution to the substrate and drying it, and consequently, an optical laminate including the substrate and the optical film placed on and bonded to the substrate may be obtained.

The optical laminate of the invention is described below. The substrate used to form the optical laminate preferably has high transparency, and therefore is preferably a glass substrate, a plastic film as described for the infinite-length substrate, or the like. The thickness of the substrate is preferably, but not limited to, from 10 to 500 μm, in view of handleability.

The substrate used as a support for the coating to form the optical film of the invention may be used as it is for the optical laminate. Alternatively, another substrate other than the support for the optical film coating may also be used.

The optical laminate of the invention may be produced using any of various methods with no particular limitation. In an embodiment, the method for producing the optical laminate of the invention includes the steps of preparing a resin solution containing the ester-based polymer and a solvent, applying the resin solution to the surface of a substrate, and drying the resin solution so that a film placed on and bonded to the substrate is formed. In another embodiment, the method may further include the step of transferring the optical film, which is placed on and bonded to the substrate, to another substrate, in addition to the steps described above.

The step of transferring the film to another substrate may include providing another substrate such as a glass plate or a polymer substrate, applying an adhesive or the like to the another substrate, bonding the optical film to the adhesive-coated surface of the another substrate, and separating the optical film from the support used for the coating so that the optical laminate is formed (this process is referred to “transfer”). In particular, an optical laminate including a substrate with low solvent resistance and the optical film of the invention placed on and bonded to the substrate is preferably formed using a method including the steps of applying the resin solution to a support with high solvent resistance and drying it to form the optical film temporarily on the support and then performing the transfer method as described above to form the optical laminate.

The substrate used for the optical laminate preferably has high transparency and typically has a total light transmittance of 85% or more, preferably 90% or more, both when the substrate is the support used for the coating and when the substrate is another one to which the film is transferred.

The optical film of the invention obtained as described above preferably has high transparency. Specifically, it preferably has a transmittance of 90% or more, more preferably 92% or more, at a wavelength of 400 nm. Such high transparency can be achieved using the ester-based polymer described above.

In the optical film of the invention, nx is preferably larger than nz (nx>nz), wherein nx is the refractive index in a direction where the in-plane refractive index is maximum, namely the direction of the slow axis, and nz is the refractive index in the thickness direction. In addition, its birefringence (Δnxz=nx−nz) in the thickness direction at a wavelength of 550 nm is preferably 0.01 or more, more preferably from 0.012 to 0.07, even more preferably from 0.015 to 0.055. The optical film having such optical properties may be used for optical compensation or the like of liquid crystal displays.

The optical film of the invention can exhibit high birefringence-producing capability as described above, because it uses the ester-based polymer described above. As is evident from the Examples described below, therefore, even a coating film with a thickness of 20 μm or less can produce a thickness direction retardation (Rth) equal to, for example, a half or quarter of a wavelength. Herein, the thickness direction retardation (Rth) is expressed as Δnxz×d, wherein d is the thickness of the optical film.

The optical film of the invention may have not only birefringence in the thickness direction but also an in-plane retardation (Δnxy=nx−ny) which can be varied by controlling the coating conditions or the stretching conditions, wherein ny is the refractive index in a direction where the in-plane refractive index is minimum, namely the direction of the fast axis.

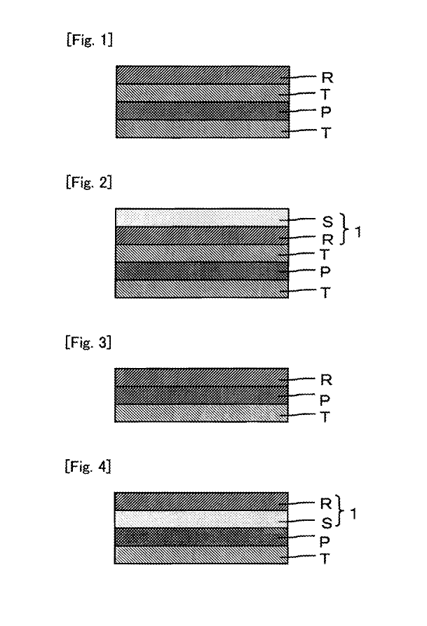

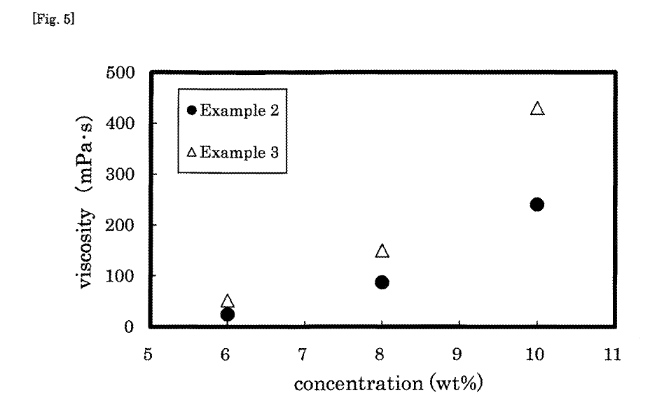

Next, the polarizing plate of the invention is described below. The polarizing plate of the invention is an optical compensation function-carrying polarizing plate having the optical film of the invention. Such a polarizing plate may have any structure, as long as it includes the optical film and a polarizer. As shown in FIG. 1, for example, the polarizing plate may be configured to include a polarizer (P), transparent protective films (T) placed on both sides of the polarizer (P), and the optical film of the invention (R) placed on the surface of one of the transparent protective films (T). Note that when the optical laminate (1) used includes a substrate (S) and the optical film (R) placed on and bonded to the substrate (S), any of the surfaces of the optical film (R) and the substrate (S) may face the transparent protective film, but the optical film of the invention (R) preferably faces the transparent protective film (T) as shown in FIG. 2.

Further, the transparent protective film may be placed on both or one side of the polarizer. When placed on both sides, for example, the transparent protective films used may be of the same type or different types.

Furthermore, in another mode, as shown in FIG. 3, the polarizing plate of the invention may include a polarizer (P), the optical film of the invention (R) placed on one surface of the polarizer (P), and the transparent protective film (T) placed on the other surface of the polarizer (P).

When the optical laminate (1) used includes a substrate (S) and the optical film (R) placed on and bonded to the substrate (R), any of the surfaces of the optical film (R) and the substrate (S) may face the polarizer (P), but the substrate (S) is preferably placed so as to face the polarizer (P). In such a structure, the substrate (S) can also serve as a transparent protective film for an optical compensation layer-carrying polarizing plate. Specifically, the transparent protective film (T) is not placed on both sides of the polarizer (P), but on one side of the polarizer (P), and the optical laminate of the invention (1) is placed on the other side such that the substrate (S) faces the polarizer (P), so that the substrate (S) of the optical laminate (1) can also serves as a transparent protective film. This structure provides a much thinner polarizing plate.

The polarizer to be used may be of various types with no particular limitation. For example, the polarizer may be a product produced by the steps of adsorbing a dichroic material such as iodine or a dichroic dye on a hydrophilic polymer film such as a polyvinyl alcohol-based film, a partially-formalized polyvinyl alcohol-based film, or a partially-saponified ethylene-vinyl acetate copolymer-based film and uniaxially stretching the film or may be a polyene-based oriented film such as a dehydration product of polyvinyl alcohol or a dehydrochlorination product of polyvinyl chloride. In particular, a polarizing layer including a polyvinyl alcohol-based film and a dichroic material such as iodine is preferred. The thickness of the polarizing layer is generally, but not limited to, about 5 to about 80 μm.

The thickness of the transparent protective film is generally from about 1 to about 500 μm preferably from 1 to 300 μm, more preferably from 5 to 200 μm, particularly preferably from 5 to 150 μm, in view of strength, workability such as handleability, thin layer formability, or the like, while it may be determined as appropriate.

When transparent protective films are provided on both sides of a polarizer, protective films made of the same polymer material or different polymer materials may be used on the front and back sides.

The optical film, optical laminate, or polarizing plate of the invention is preferably used for image displays such as liquid crystal displays, organic electroluminescence (EL) displays, and plasma display panels, while it may be used for any application. For example, such image displays may be used for OA equipment such as personal computer monitors, notebook computers, and copy machines; portable device such as cellular phones, watches, digital cameras, personal digital assistances (PDAs), and portable game machines; home appliance such as video cameras, televisions, and microwave ovens; vehicle equipment such as back monitors, monitors for car navigation systems, and car audios; display equipment such as information monitors for stores; alarm systems such as surveillance monitors; and care and medical device such as care monitors and medical monitors.

In particular, the optical film of the invention is preferably used as an optical compensation film for liquid crystal display devices in order to compensate for birefringence caused by liquid crystal cells or improve the contrast or reduce the color shift for oblique viewing of image display devices, because it has high birefringence-producing capability.

### EXAMPLES

The invention is described below with reference to examples which are not intended to limit the scope of the invention. The examples and the comparative examples were evaluated by the methods described below.

### (Glass Transition Temperature)

The glass transition temperature was determined with a differential scanning calorimeter (DSC-6200 (product name) manufactured by Seiko Instruments Inc.) by the method according to JIS K 7121 (1987) (the method for measuring the transition temperature of plastics). Specifically, 3 mg of a powdery sample was heated under a nitrogen atmosphere (gas flow rate: 50 ml/minute) from room temperature to 220° C. at a rate of temperature increase of 10° C. /minute and then cooled to 30° C. at a rate of temperature decrease of 10° C. /minute (first measurement). The sample was then heated again to 350° C. at a rate of temperature increase of 10° C. /minute (second measurement). The data obtained through the second measurement was used, and the midpoint was defined as the glass transition temperature. Temperature correction of the calorimeter was performed using a reference material (indium).

(Molecular Weight)

The weight-average molecular weight (Mw) was determined as described below. A 0.1% THF solution of each sample was prepared and filtered through a 0.45 μm membrane filter. The filtrate was then measured using a GPC system HLC-8820GPC manufactured by Tosoh Corporation and an RI detector (incorporated in the GPC system). Specifically, the column temperature and the pump flow rate were set at 40° C. and 0.35 mL/minute, respectively, and the weight-average molecular weight was determined as a polystyrene-equivalent molecular weight by a data processing using an analytical curve previously prepared with standard polystyrenes with known molecular weights. The columns used were Super HZM-M (6.0 mm diameter×15 cm), Super HZM-M (60 mm diameter×15 cm), and Super HZ2000 (60 mm diameter×15 cm) in series, and THF was used as the mobile phase.

(Δnxz)

KOBRA-WPR (trade name) manufactured by Oji Scientific Instruments was used for the measurement at a wavelength of 550 nm. The birefringence in the thickness direction (Δnxz) was calculated using the software attached to the system from the normal retardation and the retardation (R40) at a sample-tilt angle of 40°. The thickness of the film used was determined from the difference between the thickness of the polymer-coated glass and the thickness of the glass uncoated with the polymer using Dektak manufactured by Sloan Technology Corporation.

### (Transmittance)

The transmittance was measured using a spectrophotometer U-4100 manufactured by Hitachi, Ltd. at a wavelength of 400 nm.

### (Solubility Test)

The polymer was gradually added to a sample bottle containing each solvent, while the solubility was visually determined according to the criteria below.
⊙: soluble at 20% by weight or more;
◯: soluble at 10 to 20% by weight;
Δ: soluble but slightly cloudy;
x: insoluble.

### (Viscosity of Solution)

The viscosity of the solution was measured with HBDV-I (product name) manufactured by Brookfield Engineering Laboratories under the conditions: measurement temperature, 25° C.; measurement mode, low-viscosity spindle; rate, 20 to 50 rpm.

### Example 1

### (Synthesis of Ester-based Polymer)

In a reaction vessel equipped with a stirrer, 2.70 g of 2,2-bis(4-hydroxyphenyl)-4- methylpentane and 0.06 g of benzyltriethylammonium chloride were dissolved in 25 ml of a 1 M sodium hydroxide solution. A solution of 2.03 g of terephthalic acid chloride in 30 ml of chloroform was added at once to the solution under stirring and stirred at room temperature for 90 minutes. After the polymerization solution was allowed to stand and separate, the polymer-containing chloroform solution was separated, washed with an acetic acid aqueous solution and ion-exchanged water, and then poured into methanol so that the polymer was precipitated. The polymer precipitate was separated by filtration and dried under reduced pressure to give 3.41 g of a white polymer (92% yield).

### (Preparation of Optical Film)

The resulting polymer (0.1 g) was dissolved in cyclopentanone (0.5 g). The solution was applied to a glass plate by spin coating method, dried at 80° C. for 5 minutes, and then further dried at 130° C. for 30 minutes so that an optical film (with a thickness of 3.7 μm after the drying) was obtained.

### Example 2

### (Synthesis of Ester-based Polymer)

A polymer was synthesized, washed, separated by filtration, and dried, using the process of Example 1, except that 1.83 g of terephthalic acid chloride and 0.20 g of isophthalic acid chloride were used in place of 2.03 g of terephthalic acid chloride. As a result, 3.81 g of a white polymer was obtained (95% yield).

### (Preparation of Resin Solution)

The resulting polymer was dissolved in toluene to form a resin solution with a solid concentration of 6, 8, or 10% by weight.

### (Preparation of Optical Film)

The resin solution with a solid concentration of 10% by weight was used and applied to a glass plate by spin coating method and dried similarly to Example 1 so that an optical film (with a thickness of 3.7 μm after the drying) was obtained.

### Example 3

### (Preparation of Resin Solution)

A resin solution with a solid concentration of 6, 8, or 10% by weight was obtained using the process of Example 2, except that cyclopentanone was used in place of toluene.

### (Preparation of Optical Film)

An optical film was prepared using the process of Example 2, except that the resin solution with a solid concentration of 10% by weight in which the solvent was cyclopentanone was used instead.

### Example 4

Synthesis of a polymer and preparation of an optical film were performed using the process of Example 1, except that 1.52 g of terephthalic acid chloride and 0.51 g of isophthalic acid chloride were used in place of 2.03 g of terephthalic acid chloride.

### Example 5

Synthesis of a polymer and preparation of an optical film were performed using the process of Example 1, except that 1.02 g of terephthalic acid chloride and 1.02 g of isophthalic acid chloride were used in place of 2.03 g of terephthalic acid chloride.

### Example 6

Synthesis of a polymer and preparation of an optical film were performed using the process of Example 1, except that 2.42 g of 2,2-bis(4-hydroxyphenyl)butane was used in place of 2.70 g of 2,2-bis(4-hydroxyphenyl)-4-methylpentane and that 1.02 g of terephthalic acid chloride and 1.02 g of isophthalic acid chloride were used in place of 2.03 g of terephthalic acid chloride.

### Comparative Example 1

In a reaction vessel equipped with a stirrer, 2.28 g of 2,2-bis(4-hydroxyphenyl)- propane (generally called bisphenol A) and 0.06 g of benzyltriethylammonium chloride were dissolved in 25 ml of a 1 M sodium hydroxide solution. A solution of 1.83 g of terephthalic acid chloride and 0.20 g of isophthalic acid chloride in 30 ml of chloroform was added at once to the solution under stirring and stirred at room temperature for 90 minutes. After the polymerization solution was allowed to stand and separate, the polymer-containing chloroform solution was separated, washed with an acetic acid aqueous solution and ion-exchanged water, and then poured into methanol so that the polymer was precipitated. The polymer precipitate was separated by filtration and dried under reduced pressure to give 3.26 g of a white polymer (91% yield).

The resulting polymer was used in the same manner as in Example 1 in an attempt to form an optical film. However, the resin had poor solubility, and it was impossible to prepare a film.

### Comparative Example 2

A polymer was synthesized using the process of Comparative Example 1, except that 1.52 g of terephthalic acid chloride and 0.51 g of isophthalic acid chloride were used in place of 1.83 g of terephthalic acid chloride and 0.20 g of isophthalic acid chloride. The resulting polymer was used in the same manner as in Example 1 in an attempt to form an optical film. However, the resin had poor solubility, and it was impossible to prepare a film.

### Comparative Example 3

A polymer was synthesized using the process of Comparative Example 1, except that 1.02 g of terephthalic acid chloride and 1.02 g of isophthalic acid chloride were used in place of 1.83 g of terephthalic acid chloride and 0.20 g of isophthalic acid chloride. The resulting polymer was used to form an optical film in the same manner as in Example 1.

The structure and the properties of the polyester resin obtained in each of Examples 1 to 6 and Comparative Examples 1 to 3, and the properties of the resulting optical films are shown in Table 1. The viscosity of the resin solution obtained in each of Examples 2 and 3 is plotted against the solid concentration of the solution in FIG. 5.

TABLE 1

| | Polymer structure | | Properties of Polymers | | | | | | | | |
|---|---|---|---|---|---|---|---|---|---|---|---|
| | Molar | | | | | | Molecular | Heat | Resin | Properties of optical films | |
| | ratio | Substituents | Solubility test | | | | weight | resistance | solution | Birefringence | Transparency |
| | l/m | R2, R4 | CPN | CHN | Toluene | Xylene | Mw | Tg (° C.) | Solvent | Δnxz[550] | Transmittance(%) |
| Example 1 | 100/0 | i-Bu | ⊙ | ⊙ | ⊙ | ⊙ | 186000 | 206 | CPN | 0.028 | 92 |
| Example 2 | 90/10 | i-Bu | ⊙ | ⊙ | ⊙ | ⊙ | 97000 | 202 | Toluene | 0.024 | 92 |
| Example 3 | | | | | | | | | CPN | 0.022 | 92 |
| Example 4 | 75/25 | i-Bu | ⊙ | ⊙ | ⊙ | ⊙ | 288000 | 201 | CPN | 0.025 | 92 |
| Example 5 | 50/50 | i-Bu | ⊙ | ⊙ | ⊙ | ⊙ | 278000 | 189 | CPN | 0.019 | 92 |
| Example 6 | 50/50 | Et | ⊙ | ⊙ | Δ | Δ | 179000 | 195 | CPN | 0.023 | 92 |
| Comparative | 90/10 | Me | X | X | X | X | — | — | CPN | — | — |
| Example 1 | | | | | | | | | | | |
| Comparative | 75/25 | Me | X | X | X | X | 142000 | 205 | CPN | — | — |
| Example 2 | | | | | | | | | | | |
| Comparative | 50/50 | ME | ⊙ | ⊙ | X | X | 155000 | 200 | CPN | 0.021 | 92 |
| Example 3 | | | | | | | | | | | |

In the table, 1/m represents the molar ratio between the respective repeating units in the ester-based copolymer, and R2 and R4 each represent the substituent in general formula (V) below. The symbols i-Bu, Et, and Me represent isobutyl, ethyl, and methyl, respectively, and CPN and CHN represent cyclopentanone and cyclohexanone, respectively.

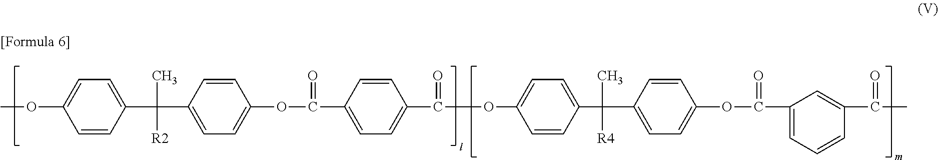

All the optical films prepared in Examples 1 to 6 exhibited high transparency. In the examples except for Example 2, a glass plate and cyclopentanone were used as the substrate and the solvent, respectively, for convenience of sample preparation and comparison with the comparative examples. Even when a polymer substrate is used or when toluene or xylene is used as the solvent, film production is possible with the ester-based polymers of the examples, and optical films having the same optical properties as those in the examples can be obtained using the ester-based polymers of the examples, because the ester-based polymers used for the optical films of the examples can exhibit high solubility.

FIG. 5 also shows that toluene used as the solvent can keep the viscosity of the resin solution at a relatively low level, even when the ester-based polymer solid concentration becomes high. A comparison between Examples 2 and 3 shows that the Δnxz of the resulting optical film is larger when toluene is used the solvent for the resin solution than when cyclopentanone is used.

The ester-based polymer had poor solubility in each of Comparative Examples 1 and 2 using bisphenol A (both R1 and R2 are methyl) as the bisphenol component.

1. A method for producing an optical compensation film, comprising the steps of:
preparing a resin solution comprising an ester-based polymer represented by formula (I) and a solvent; 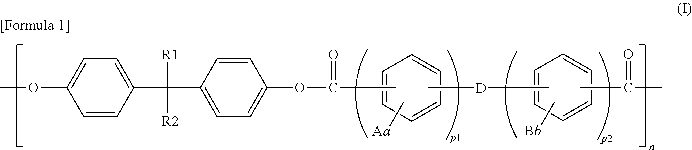
applying the resin solution on a substrate; and
drying the resin solution to form a film on the substrate.

2. The method according to claim 1, further comprising transferring the film to another substrate.

3. The method according to claim 1, wherein the solvent comprises 50 parts by weight or more of toluene, based on 100 parts by weight of the solvent.

4. The method according to claim 1, wherein in formula (I), R1 is a methyl group, and R2 is a straight-chain or branched alkyl group of 2 to 4 carbon atoms.

5. The method according to claim 1, wherein the ester-based polymer is a non-halogenated ester-based polymer having no halogen atom in its chemical structure.

6. The method according to claim 1, wherein a refractive index (nz) of the film in a film thickness direction is smaller than the maximum (nx) of its in-plane refractive index.

7. The method according to claim 6, wherein a birefringence (Δnxz=nx−nz) in the film thickness direction at a wavelength of 550 nm is 0.01 or more.

8. The method according to claim 1, wherein the film has a transmittance of 90% or more at a wavelength of 400 nm.

9. The method according to claim 1, wherein the film has a thickness of 20 μm or less.
